(19) United States
(12) Patent Application Publication
(10) Pub. No.: US 2024/0137768 A1
(43) Pub. Date: Apr. 25, 2024

(54) AUTOMATIC DYNAMIC SECURE CONNECTION SYSTEM AND METHOD THEREOF

(71) Applicant: CHELPIS CO., LTD., Taipei (TW)

(72) Inventor: CHIA-YEN LU, Taipei (TW)

(21) Appl. No.: 17/971,481

(22) Filed: Oct. 20, 2022

(51) Int. Cl. H04W 12/121; G06N 20/00; H04W 12/08

(52) U.S. Cl. CPC H04W 12/121; G06N 20/00; H04W 12/08

(57) ABSTRACT

An automatic dynamic secure connection system and a method thereof, the automatic dynamic secure connection method comprises following steps: at least one user equipment executing a software program to generate at least one execution information; a central processing unit of an equipment information judging device receiving the execution information and capturing an abnormal information in the execution information; the central processing unit comparing and judging the abnormal information with a whitelist database, a malicious behavior feature database and a blacklist database, and integrating with an artificial intelligence model analysis result, and then generating a judgment result according to a set condition; and the central processing unit determining whether to adjust a connection behavior according to the judgment result, thereby, the automatic dynamic secure connection system is capable of judging a software execution status to adjust the connection behavior in order to achieve an efficacy of avoiding malicious cyber attacks.

### BACKGROUND OF THE INVENTION

### Field of Invention

The invention relates to an automatic dynamic secure connection system and a method thereof capable of judging a software execution status to adjust a connection behavior in order to avoid malicious cyber attacks.

### Related Art

With the development of the Internet and digital information, computers and electronic devices have become the communication tools for each member of an enterprise or organization, and the communication between them is mainly through the network to transmit data. Although transmission through the network is convenient and fast, network information transmission also brings many risks such as data theft and virus dissemination. Therefore, in order to ensure the security of the Internet, how to prevent cyber attacks is a major issue. Therefore, enterprises will establish multiple network security management systems in the network environment, such as isolation through firewalls or anti-virus programs, to prevent intentional people from stealing information from outside the corporate and spreading computer viruses. But with the diversity of Internet transmission methods, the single-type cyber attack behaviors in the past have begun to transform into compound attack behaviors or new attack methods. Therefore, the aforementioned security management system still has loopholes and cannot immediately cope with the updated attack methods of network hackers, it cannot prevent data leakage caused by improper operation of members, or intentional people from stealing information and invading the system through the corporate intranet or computer.

Therefore, the inventor of the invention and relevant manufacturers engaged in this industry are eager to research and make improvement to solve the above-mentioned problems and drawbacks in the prior art.

### SUMMARY OF THE INVENTION

Therefore, in order to effectively solve the above-mentioned problems, a main object of the invention is to provide an automatic dynamic secure connection system and a method thereof capable of judging a software execution status to adjust a connection behavior in order to avoid malicious cyber attacks.

A secondary object of the invention is to provide an automatic dynamic secure connection system and a method thereof capable of effectively updating a software execution status to correspond to updated malicious cyber attacks.

In order to achieve the above objects, the invention provides an automatic dynamic secure connection system comprising: at least one user equipment; and at least one equipment information judging device, the equipment information judging device has a central processing unit and is electrically connected to the user equipment, the user equipment executes a software program to generate at least one execution information, the central processing unit receives the execution information and captures an abnormal information in the execution information, the central processing unit compares and judges the abnormal information with a whitelist database, a malicious behavior feature database and a blacklist database, and integrates with an artificial intelligence model analysis result, and then generates a judgment result according to a set condition, and the central processing unit determines whether to adjust a connection behavior according to the judgment result.

According to one embodiment of the automatic dynamic secure connection system of the invention, wherein the equipment information judging device is provided with a connection unit, the connection unit is electrically connected to the central processing unit, and the central processing unit determines whether to adjust a connection behavior of the connection unit according to the judgment result.

According to one embodiment of the automatic dynamic secure connection system of the invention, wherein the equipment information judging device further has an information capture unit, the information capture unit captures the abnormal information and generates at least one fixed feature data and at least one dynamic feature data from the abnormal information.

According to one embodiment of the automatic dynamic secure connection system of the invention, further comprising a servo equipment, the servo equipment being signally connected to the user equipment, the servo equipment having a training unit and a condition updating unit, the servo equipment receiving the fixed feature data and the dynamic feature data and transmitting the fixed feature data and the dynamic feature data to the training unit, so that the training unit capturing the fixed feature data and the dynamic feature data, generating an updated training model, and transmitting the updated training model to the artificial intelligence model for optimization.

According to one embodiment of the automatic dynamic secure connection system of the invention, wherein the equipment information judging device further comprises an original information processing unit, the original information processing unit is electrically connected to the central processing unit and the artificial intelligence model, the abnormal information captured by the central processing unit is transmitted to the original information processing unit and the original information processing unit filters noise.

According to one embodiment of the automatic dynamic secure connection system of the invention, wherein the servo equipment further has an update information processing unit, the update information processing unit is signally connected to the information capture unit and the training unit, the update information processing unit receives the fixed feature data and the dynamic feature data and generates an updated malicious behavior feature data and transmits the updated malicious behavior feature data to the training unit, so that the training unit captures the updated malicious behavior feature data and generates the updated training model and transmits the updated training model to the artificial intelligence model for optimization.

According to one embodiment of the automatic dynamic secure connection system of the invention, wherein the servo equipment further has a condition updating unit, the condition updating unit is signally connected to the training unit and the artificial intelligence model, and the condition updating unit receives the updated training model and transmits the updated training model to the artificial intelligence model for optimization.

According to one embodiment of the automatic dynamic secure connection system of the invention, wherein the condition updating unit is signally connected to the whitelist database, the malicious behavior feature database and the blacklist database, the condition updating unit receives at least one updated whitelist data, at least one updated malicious behavior feature data and at least one updated blacklist data and transmits the at least one updated whitelist data, the at least one updated malicious behavior feature data and the at least one updated blacklist data to the whitelist database, the malicious behavior feature database and the blacklist database, respectively.

According to one embodiment of the automatic dynamic secure connection system of the invention, wherein the servo equipment further comprises a control center, the control center is signally connected to the condition updating unit, the whitelist database, the malicious behavior feature database, the blacklist database and the artificial intelligence model, the control center receives the updated training model, the updated whitelist data, the updated malicious behavior feature data and the updated blacklist data of the condition updating unit, and transmits the updated training model, the updated whitelist data, the updated malicious behavior feature data and the updated blacklist data to the artificial intelligence model, the whitelist database, the malicious behavior feature database and the blacklist database, respectively.

The invention further provides an automatic dynamic secure connection method comprising:
at least one user equipment executing a software program to generate at least one abnormal information;
a central processing unit of an equipment information judging device receiving the abnormal information and comparing and judging the abnormal information with a whitelist database, a malicious behavior feature database, a blacklist database and an artificial intelligence model, and then generating a judgment result according to a set condition; and
the central processing unit determining whether to adjust a connection behavior according to the judgment result.

According to one embodiment of the automatic dynamic secure connection method of the invention, wherein the equipment information judging device is provided with a connection unit, the connection unit is electrically connected to the central processing unit, and the central processing unit determines whether to adjust a connection behavior of the connection unit according to the judgment result.

According to one embodiment of the automatic dynamic secure connection method of the invention, an information capture unit of the equipment information judging device capturing the abnormal information and generating at least one fixed feature data and at least one dynamic feature data from the abnormal information.

According to one embodiment of the automatic dynamic secure connection method of the invention, a servo equipment receiving the fixed feature data and the dynamic feature data and transmitting the fixed feature data and the dynamic feature data to a training unit, the training unit capturing the fixed feature data and the dynamic feature data, generating an updated training model, and transmitting the updated training model to the artificial intelligence model for optimization.

According to one embodiment of the automatic dynamic secure connection method of the invention, wherein the abnormal information captured by the central processing unit is transmitted to an original information processing unit and the original information processing unit filters noise.

According to one embodiment of the automatic dynamic secure connection method of the invention, wherein an update information processing unit of the servo equipment receives the fixed feature data and the dynamic feature data and generates an updated malicious behavior feature data and transmits the updated malicious behavior feature data to the training unit, the training unit captures the updated malicious behavior feature data and generates an updated training model and transmits the updated training model to the artificial intelligence model for optimization.

According to one embodiment of the automatic dynamic secure connection method of the invention, wherein a condition updating unit of the servo equipment receives the updated training model and transmits the updated training model to the artificial intelligence model for optimization.

According to one embodiment of the automatic dynamic secure connection method of the invention, wherein the condition updating unit receives at least one updated whitelist data, at least one updated malicious behavior feature data and at least one updated blacklist data and transmits the at least one updated whitelist data, the at least one updated malicious behavior feature data and the at least one updated blacklist data to the whitelist database, the malicious behavior feature database and the blacklist database, respectively.

According to one embodiment of the automatic dynamic secure connection method of the invention, wherein a control center of the servo equipment receives the updated training model, the updated whitelist data, the updated malicious behavior feature data and the updated blacklist data of the condition updating unit, and transmits the updated training model, the updated whitelist data, the updated malicious behavior feature data and the updated blacklist data to the artificial intelligence model, the whitelist database, the malicious behavior feature database and the blacklist database, respectively.

### BRIEF DESCRIPTION OF THE DRAWINGS

FIG. 1 is a schematic diagram of a system framework of an automatic dynamic secure connection system of the invention.

FIG. 2 is a schematic diagram of implementation of the system framework of the automatic dynamic secure connection system of the invention.

FIG. 3 is a schematic diagram of the system framework of the automatic dynamic secure connection system with a servo equipment according to the invention.

FIG. 4 is a schematic diagram of implementation of the system framework of the automatic dynamic secure connection system with the servo equipment according to the invention.

FIG. 5 is a schematic diagram of the system framework of the automatic dynamic secure connection system with a control center according to the invention.

FIG. 6 is a flow chart of an automatic dynamic secure connection method of the invention.

FIG. 7 is a flow chart of the automatic dynamic secure connection method with the servo equipment according to the invention.

### DETAILED DESCRIPTION OF THE INVENTION

The above objects of the invention, as well as its structural and functional features, will be described in accordance with the preferred embodiments of the accompanying drawings.

In the following, for the formation and technical content related to an automatic dynamic secure connection system and a method thereof of the invention, various applicable examples are exemplified and explained in detail with reference to the accompanying drawings; however, the invention is of course not limited to the enumerated embodiments, drawings, or detailed descriptions.

Furthermore, those who are familiar with this technology should also understand that the enumerated embodiments and accompanying drawings are only for reference and explanation, and are not used to limit the invention; other modifications or alterations that can be easily implemented based on the detailed descriptions of the invention are also deemed to be within the scope without departing from the spirit or intention thereof as defined by the appended claims and their legal equivalents.

And, the directional terms mentioned in the following embodiments, for example: “above”, “below”, “left”, “right”, “front”, “rear”, etc. are only directions referring in the accompanying drawings. Therefore, the directional terms are used to illustrate rather than limit the invention. In addition, in the following embodiments, the same or similar elements will be labeled with the same or similar numerals.

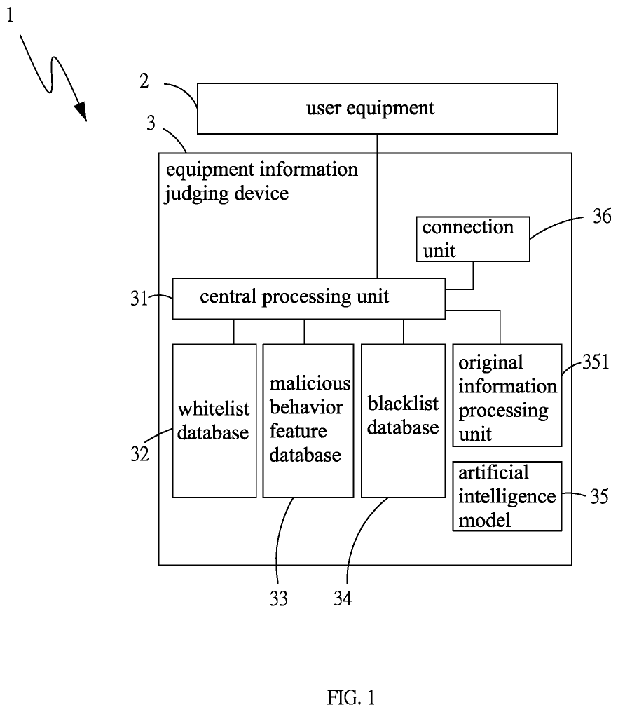

Please refer to FIG. 1 for a schematic diagram of a system framework of an automatic dynamic secure connection system of the invention, wherein an automatic dynamic secure connection system 1 comprises at least one user equipment 2 and at least one equipment information judging device 3, wherein the user equipment 2 and the equipment information judging device 3 can be two separate devices and are electrically connected with each other, or the equipment information judging device 3 is disposed in the user equipment 2 and is electrically connected to the user equipment 2.

Wherein the user equipment 2 is installed with a software program or a processor is installed with a software program such as operating software, background program, and the user equipment 2 executes the software program to generate at least one execution information.

Wherein the equipment information judging device 3 comprises a central processing unit 31, wherein the central processing unit 31 is a processing module such as MCU, CPU, which is installed with software and is capable of performing comparison and judgment and changing a connection behavior, the central processing unit 31 is signally connected to the user equipment 2, the equipment information judging device 3 stores a whitelist database 32, a malicious behavior feature database 33 and a blacklist database 34, and is built with an artificial intelligence model 35, an original information processing unit 351 can be connected between the artificial intelligence model 35 and the central processing unit 31, or the artificial intelligence model 35 can be directly connected to the central processing unit 31, and the original information processing unit 351 is not disposed between the artificial intelligence model 35 and the central processing unit 31. In this embodiment, the original information processing unit 351 is provided as an implementation manner, wherein data in the whitelist database 32 can be programs developed by the system or programs required for operation of the user equipment 2; data in the malicious behavior feature database 33 can be characteristics of malicious behaviors, or status of snooping programs, or searching for file names or information of key components of an operating system; and data in the blacklist database 34 can be virus codes, indicators of compromise (IoCs), but are not limited thereto. Data in each of the databases are mainly defined by a user. Overall, data in the whitelist database 32 are non-malicious program information, data in the blacklist database 34 and the malicious behavior feature database 33 are malicious program information or actions. The central processing unit 31 is signally connected to the whitelist database 32, the malicious behavior feature database 33 and the blacklist database 34. The equipment information judging device 3 is further provided with a connection unit 36, the connection unit 36 performs network connection of the user equipment 2 by a connection behavior, wherein the connection behavior can comprise communication protocols, connection paths, connection keys, connection ports, reconnection, disconnection, which can be used for network connection.

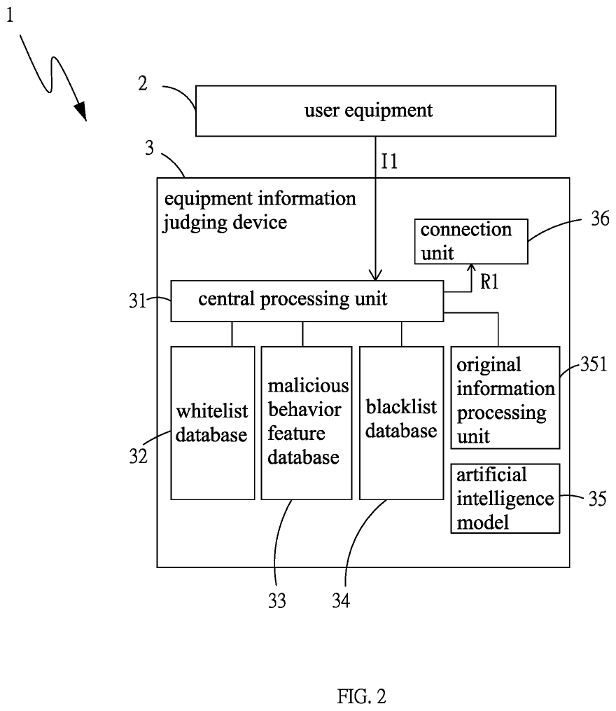

Please refer to FIG. 2 for a schematic diagram of implementation of the system framework of the automatic dynamic secure connection system of the invention, wherein the central processing unit 31 receives an execution information generated by the user equipment 2 executing a software program, if the execution information is interfered by a third party program, the central processing unit 31 captures an abnormal information I1 in the execution information, wherein interference of the third party program can be malicious program or malicious program behavior information, wherein malicious program or malicious program behavior information can be, for example, Trojan horse program information or behaviors generated by Trojan horse programs, etc., or the malicious program may read, modify or erase the abnormal information I1. So if there is interference by the third party program, the central processing unit 31 detects a malicious program in the execution information or the abnormal information I1 being read, modified or erased by the malicious program through endpoint detection and response (EDR). The central processing unit 31 has the abnormal information I1, the central processing unit 31 captures data of the whitelist database 32, the malicious behavior feature database 33 and the blacklist database 34, respectively, and compares the data with the abnormal information Il, and inputs the abnormal information I1 into the artificial intelligence model 35 for analyzing by the artificial intelligence model 35. The central processing unit 31 integrates comparison results of the whitelist database 32, the malicious behavior feature database 33 and the blacklist database 34 with results analyzed by the artificial intelligence model 35, and the central processing unit 31 generates a judgment result R1 from the integrated results according to a set condition. The original information processing unit 351 receives the abnormal information I1 and converts the abnormal information I1 into an information format that can be interpreted by the artificial intelligence model 35 and then filters noise for the artificial intelligence model 35 to analyze and judge, but the abnormal information I1 can be directly analyzed and judged by the artificial intelligence model 35 without going through the original information processing unit 351.

Wherein the set condition of the central processing unit 31 can be set by requirement or priority condition of the user equipment 2, the set condition based on requirement of the user equipment 2 can be, for example, setting a single database for comparison and judgment, multiple databases for comparison and judgment, multiple databases for comparison and the artificial intelligence model 35 for analysis and judgment, a single database for comparison and the artificial intelligence model 35 for analysis and judgment, or only the artificial intelligence model 35 for comparison and judgment; the set condition based on priority condition can be, for example, when database comparison and analysis and judgment results of the artificial intelligence model 35 are inconsistent, judgment based on one of the databases or the artificial intelligence model 35 is used as a basis, but it is not limited thereto.

In this embodiment, the set condition of the central processing unit 31 is a single database for comparison and judgment, wherein the central processing unit 31 compares and judges the abnormal information Il with the data in the whitelist database 32, if content of the abnormal information Il matches the data in the whitelist database 32, it is determined that the abnormal information Il is not information generated by malicious attacks, the central processing unit 31 generates the judgment result R1 of non-malicious attacks, and the central processing unit 31 does not adjust a connection behavior of the connection unit 36.

In addition, in this embodiment, the set condition of the central processing unit 31 is a single database for comparison and judgment, wherein the central processing unit 31 compares and judges the abnormal information Il with the data in the blacklist database 34, if content of the abnormal information Il is the data in the blacklist database 34, it is determined that the abnormal information Il is information generated by malicious attacks, the central processing unit 31 generates the judgment result R1 of malicious attacks, and the central processing unit 31 adjusts a connection behavior of the connection unit 36. Adjustment of the connection behavior is, for example, changing original connection path, changing connection key, changing the Internet communication protocol, changing connection port of non-device interface, such as connection port in TCP/IP protocol, port 80 for web browsing service, port 21 for FTP, changes in connection behavior such as network reconnection or network disconnection.

In addition, in this embodiment, the set condition of the central processing unit 31 is performed in a multiple comparisons and judgments manner, and the multiple comparisons and judgments can be sequential judgments or simultaneous judgments. In the case of sequential judgments, the central processing unit 31 first compares and judges the abnormal information Il with the data in the whitelist database 32. If content of the abnormal information Il matches the data in the whitelist database 32, the central processing unit 31 then compares and judges the abnormal information Il with the data in the malicious behavior feature database 33. If content of the abnormal information Il does not match the data in the malicious behavior feature database 33, the central processing unit 31 then compares and judges the abnormal information Il with the data in the blacklist database 34. If content of the abnormal information Il is not the data in the blacklist database 34, the central processing unit 31 then sends the abnormal information Il to the artificial intelligence model 35 for interpretation. When the artificial intelligence model 35 determines that the abnormal information I1 is not information generated by malicious attacks, the central processing unit 31 generates the judgment result R1 of non-malicious attacks and does not adjust a connection behavior of the connection unit 36. During judgment, the central processing unit 31 simultaneously interprets the abnormal information Il with the whitelist database 32, the malicious behavior feature database 33 and the blacklist database 34 by the artificial intelligence model 35. Alternatively, when the set condition of the central processing unit 31 is determined by multiple comparisons and judgment and has priority condition, content of the abnormal information Il may match the data in the whitelist database 32, while content of the abnormal information Il is the data in the blacklist database 34. Therefore, when results of the central processing unit 31 in comparing the whitelist database 32 and the blacklist database 34 are conflicted, the priority condition of the set condition is determined as a final result, so that if a first order determined by the priority condition is the whitelist database 32, it can be set as the set condition as long as content of the abnormal information Il matches the data in the whitelist database 32, and the central processing unit 31 generates the judgment result R1 of non-malicious attacks and does not adjust a connection behavior of the connection unit 36.

In addition, in this embodiment, the set condition of the central processing unit 31 is to compare and judge multiple databases with the artificial intelligence model 35, and a manner of comparing and judging can be sequential judgement or simultaneous judgement. If it is sequential judgement, the central processing unit 31 compares and judges the abnormal information Il with the data in the whitelist database 32, if the central processing unit 31 cannot determine, the central processing unit 31 then compares and judges the abnormal information Il with the data in the malicious behavior feature database 33. If the central processing unit 31 is unable to judge, the central processing unit 31 further compares and judges the abnormal information Il with the data in the blacklist database 34. When the central processing unit 31 is also unable to judge, the abnormal information Il is interpreted by the artificial intelligence model 35, that is, when the central processing unit 31 is unable to judge by the whitelist database 32, the malicious behavior feature database 33 and the blacklist database 34, the artificial intelligence model 35 makes comparison and judgment. Alternatively, if it is simultaneous judgement, the central processing unit 31 interprets the abnormal information Il with the whitelist database 32, the malicious behavior feature database 33 and the blacklist database 34 by the artificial intelligence model 35. When the abnormal information Il is compared and judged with the data in the whitelist database 32, the malicious behavior feature database 33 and the blacklist database 34, the artificial intelligence model 35 determines whether the abnormal information Il is information generated by malicious attacks. The central processing unit 31 receives interpretation of the artificial intelligence model 35 to generate the judgment result R1 and decides whether to adjust a connection behavior of the connection unit 36 according to the judgment result R1. Thereby, the automatic dynamic secure connection system 1 is capable of judging a software execution status to adjust the connection behavior in order to achieve an efficacy of avoiding malicious cyber attacks.

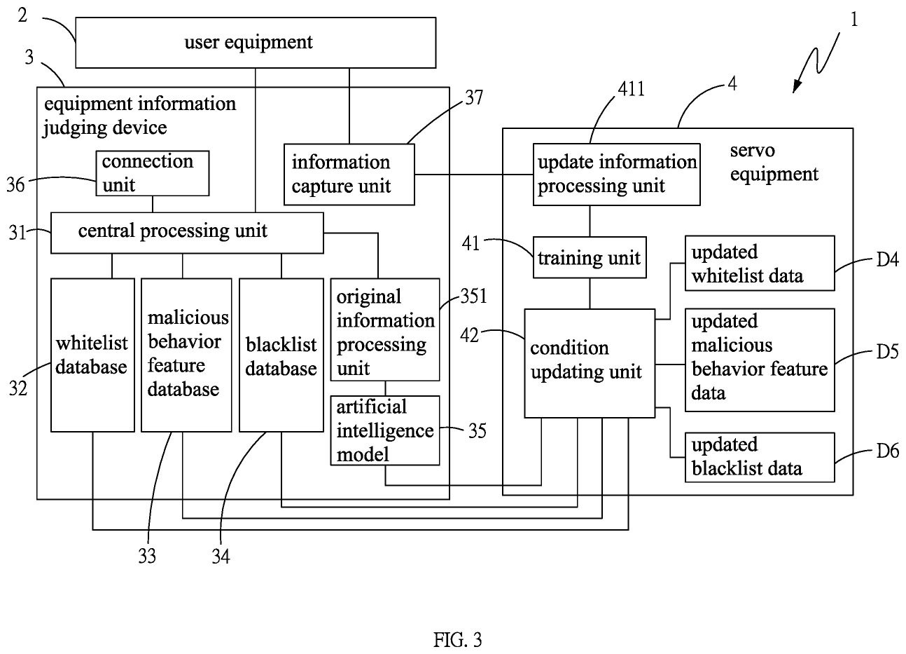

Please refer to FIG. 3 for a schematic diagram of the system framework of the automatic dynamic secure connection system with a servo equipment according to the invention, wherein the automatic dynamic secure connection system 1 further comprises a servo equipment 4, and the servo equipment 4 is signally connected to the equipment information judging device 3. The equipment information judging device 3 has an information capture unit 37, the information capture unit 37 is signally connected to the user equipment 2, the servo equipment 4 has a training unit 41 and a condition updating unit 42, and the equipment information judging device 3 is signally connected to the training unit 41 via the information capture unit 37, wherein the information capture unit 37 uses an endpoint detection and response (EDR) mechanism to capture the abnormal information IL An update information processing unit 411 can be connected between the training unit 41 and the information capture unit 37, or the training unit 41 can be directly connected to the information capture unit 37, and the update information processing unit 411 is not disposed between the training unit 41 and the information capture unit 37. In this embodiment, the update information processing unit 411 is provided as an implementation manner. The condition updating unit 42 is signally connected to the training unit 41 and the artificial intelligence model 35, and the condition updating unit 42 is also signally connected to the whitelist database 32, the malicious behavior feature database 33 and the blacklist database 34. The condition updating unit 42 receives at least one updated whitelist data D4, at least one updated malicious behavior feature data D5 and at least one updated blacklist data D6.

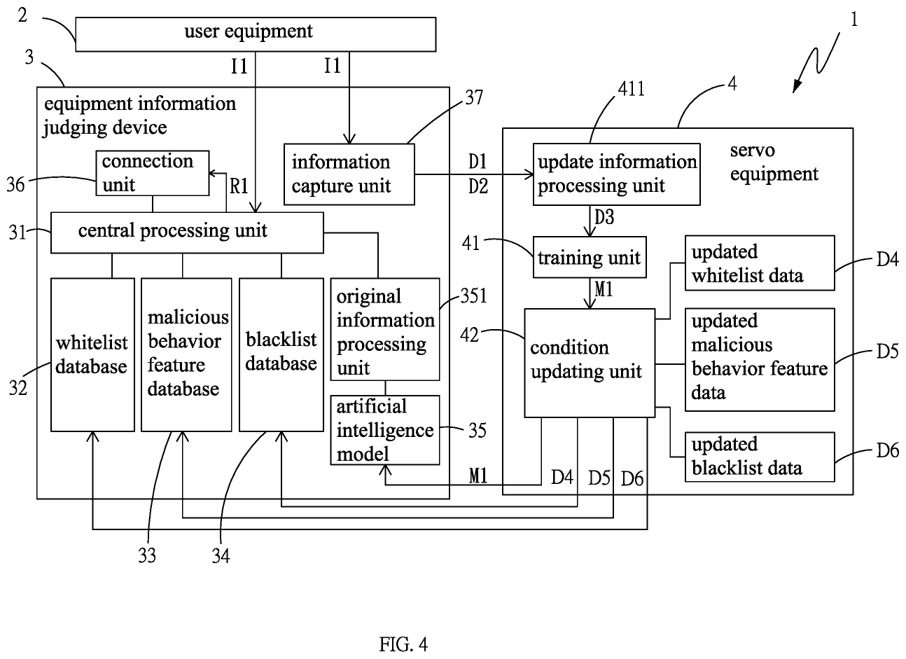

Please refer to FIG. 4 for a schematic diagram of implementation of the system framework of the automatic dynamic secure connection system with the servo equipment according to the invention, wherein the information capture unit 37 captures information of the abnormal information Il and generates at least one fixed feature data D1 and at least one dynamic feature data D2 from fixed features and dynamic features in the information. The fixed feature data D1 can comprise data such as file content access, file hashing, computer file digital signatures, computer system resources, signer information, computer coupling. The dynamic feature data D2 can comprise data such as file changes, computer call path changes, computer system resources, file attribute changes, and the files comprise computer files, scripting languages, device files, database files.

The fixed feature data D1 and the dynamic feature data D2 generated by the information capture unit 37 are transmitted to the update information processing unit 411, or the fixed feature data D1 and the dynamic feature data D2 generated by the information capture unit 37 are directly transmitted to the training unit 41. In this embodiment, the fixed feature data D1 and the dynamic feature data D2 are firstly transmitted to the update information processing unit 411 as an implementation manner, wherein the update information processing unit 411 is mainly used to facilitate training of the training unit 41, but it is not limited thereto. The update information processing unit 411 receives the fixed feature data D1 and the dynamic feature data D2 and converts the fixed feature data D1 and the dynamic feature data D2 into an updated feature processing data D3 of an information format that can be determined by the artificial intelligence model 35 and for filtering noise, and the update information processing unit 411 transmits the updated feature processing data D3 to the training unit 41. The training unit 41 captures the updated feature processing data D3 and generates an updated training model M1, wherein the updated training model M1 generated by the training unit 41 can be transmitted to the condition updating unit 42, and the condition updating unit 42 receives the updated training model M1 and transmits the updated training model M1 to the artificial intelligence model 35 for updating and optimization. After the condition updating unit 42 receives the updated whitelist data D4, the updated malicious behavior feature data D5 and the updated blacklist data D6, the condition updating unit 42 transmits the updated whitelist data D4, the updated malicious behavior feature data D5 and the updated blacklist data D6 to the whitelist database 32, the malicious behavior feature database 33 and the blacklist database 34, respectively, so that data in the whitelist database 32, the malicious behavior feature database 33 and the blacklist database 34 can be updated. When the central processing unit 31 judges the abnormal information I1, the central processing unit 31 compares and judges the whitelist database 32, the malicious behavior feature database 33 and the blacklist database 34 of updated data with the optimized artificial intelligence model 35. Thereby, the automatic dynamic secure connection system 1 is capable of achieving an efficacy of effectively updating a software execution status to correspond to updated malicious cyber attacks.

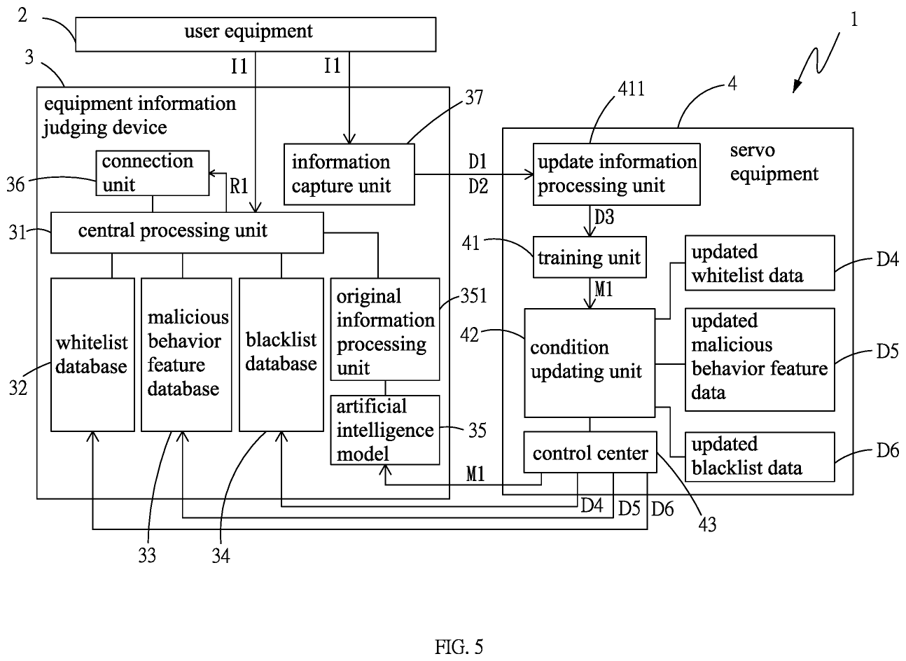

Please refer to FIG. 5 for a schematic diagram of the system framework of the automatic dynamic secure connection system with a control center according to the invention, wherein the servo equipment 4 further comprises a control center 43, the control center 43 is signally connected to the condition updating unit 42, the whitelist database 32, the malicious behavior feature database 33, the blacklist database 34 and the artificial intelligence model 35, and the control center 43 performs secure connection and data control with the equipment information judging device 3 in the servo equipment 4, and data confirmation and updated data management with the user equipment 2. The control center 43 receives the updated training model M1, the updated whitelist data D4, the updated malicious behavior feature data D5 and the updated blacklist data D6 of the condition updating unit 42, and the control center 43 transmits the updated training model M1 to the artificial intelligence model 35 to optimize the artificial intelligence model 35, and transmits the updated whitelist data D4, the updated malicious behavior feature data D5 and the updated blacklist data D6 to the whitelist database 32, the malicious behavior feature database 33 and the blacklist database 34, respectively, so that data in the whitelist database 32, the malicious behavior feature database 33 and the blacklist database 34 can be updated. When the central processing unit 31 judges the abnormal information I1, the central processing unit 31 compares and judges the whitelist database 32, the malicious behavior feature database 33 and the blacklist database 34 of updated data with the optimized artificial intelligence model 35. Thereby, the automatic dynamic secure connection system 1 is capable of achieving an efficacy of effectively updating a software execution status to correspond to updated malicious cyber attacks.

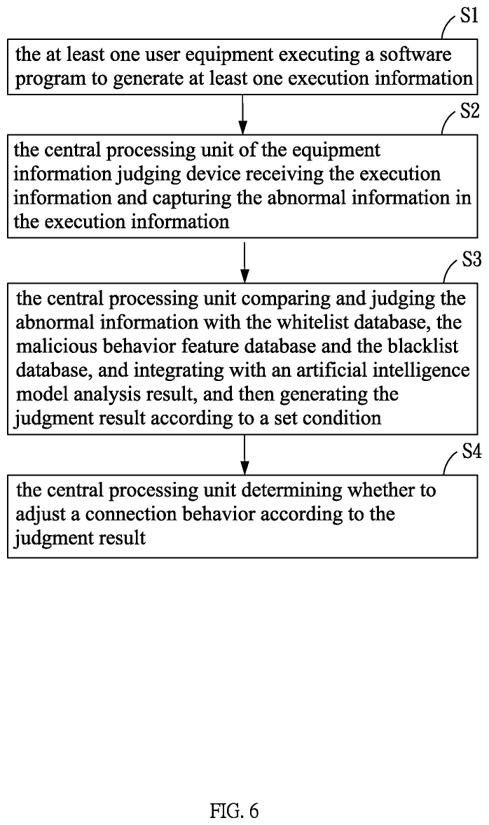

In order to clearly illustrate an operation process of this embodiment, please refer to FIG. 6 for a flow chart of an automatic dynamic secure connection method of the invention. The automatic dynamic secure connection method comprises following steps:
step S1: the at least one user equipment 2 executing a software program to generate at least one execution information, wherein the user equipment 2 is installed with a software program or a processor is installed with a software program, and the user equipment 2 executes the software program to generate the execution information;
step S2: the central processing unit 31 of the equipment information judging device 3 receiving the execution information and capturing the abnormal information I1 in the execution information, wherein if the execution information is interfered by a third party program, the central processing unit 31 captures the abnormal information Il in the execution information;
step S3: the central processing unit 31 comparing and judging the abnormal information Il with the whitelist database 32, the malicious behavior feature database 33 and the blacklist database 34, and integrating with an artificial intelligence model analysis result, and then generating the judgment result R1 according to a set condition, wherein the central processing unit 31 receives the execution information generated by the user equipment 2 executing the software program, if the execution information is interfered by a third party program, the central processing unit 31 captures the abnormal information Il in the execution information, after the central processing unit 31 has the abnormal information Il, the central processing unit 31 captures data of the whitelist database 32, the malicious behavior feature database 33 and the blacklist database 34 respectively and compares with the abnormal information I1, and inputs the abnormal information Il into the artificial intelligence model 35 for analyzing by the artificial intelligence model 35, the central processing unit 31 integrates comparison results of the whitelist database 32, the malicious behavior feature database 33 and the blacklist database 34 with results analyzed by the artificial intelligence model 35, and the central processing unit 31 generates the judgment result R1 from the integrated results according to the set condition, wherein the set condition of the central processing unit 31 can be set by requirement or safety factor of the user equipment 2, the set condition can be, for example, setting a single database for comparison and judgment, multiple databases for comparison and judgment, multiple databases for comparison and the artificial intelligence model 35 for comparison and judgment, a single database for comparison and the artificial intelligence model 35 for comparison and judgment, only the artificial intelligence model 35 for comparison and judgment, or priority condition for comparison and judgment, but it is not limited thereto, the central processing unit 31 compares the abnormal information Il with the whitelist database 32, the malicious behavior feature database 33, the blacklist database 34 and the artificial intelligence model 35 according to the set condition, and the central processing unit 31 generates the judgment result R1, after the central processing unit 31 receives the abnormal information Il, the central processing unit 31 transmits the abnormal information Il to the original information processing unit 351 and the original information processing unit 351 filters noise; and
step S4: the central processing unit 31 determining whether to adjust a connection behavior according to the judgment result R1, wherein the central processing unit 31 determines whether to adjust a connection behavior of the connection unit 36 according to the judgment result R1, adjustment of the connection behavior is, for example, changing original connection path, changing connection key, changing the Internet communication protocol, changing connection port of non-device interface, such as connection port in TCP/IP protocol, port 80 for web browsing service, port 21 for FTP, changes in connection behavior such as network reconnection or network disconnection, thereby, the automatic dynamic secure connection system 1 is capable of judging a software execution status to adjust the connection behavior in order to achieve an efficacy of avoiding malicious cyber attacks.

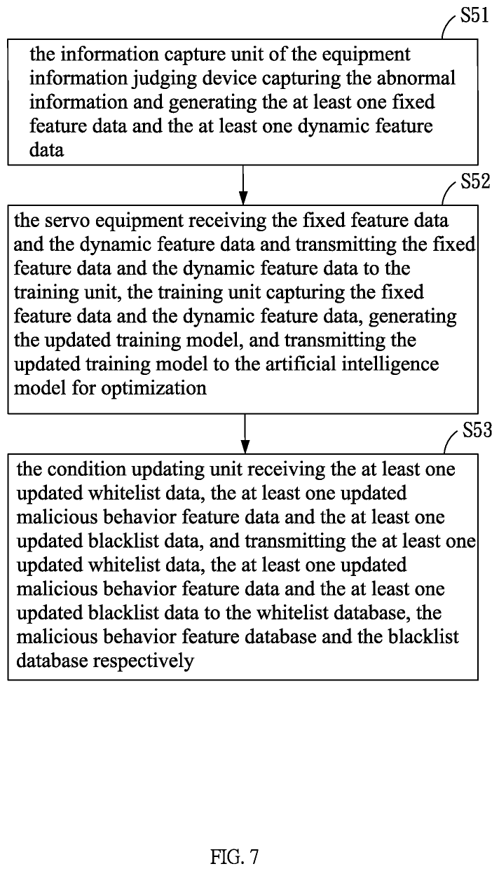

Please refer to FIG. 7 for a flow chart of the automatic dynamic secure connection method with the servo equipment according to the invention, wherein the step S4 can be followed by following steps, and the following steps can also be executed simultaneously with the aforementioned steps;
step S51: the information capture unit 37 of the equipment information judging device 3 capturing the abnormal information Il and generating the at least one fixed feature data D1 and the at least one dynamic feature data D2, wherein the information capture unit 37 receives the abnormal information Il, the information capture unit 37 captures information of the abnormal information Il and generates the at least one fixed feature data D1 and the at least one dynamic feature data D2 from fixed features and dynamic features in the information, the fixed feature data D1 can comprise data such as file content access, file hashing, computer file digital signatures, computer system resources, signer information, computer coupling, the dynamic feature data D2 can comprise data such as file changes, computer call path changes, computer system resources, file attribute changes, and the files comprise computer files, scripting languages, device files, database files;
step S52: the servo equipment 4 receiving the fixed feature data D1 and the dynamic feature data D2 and transmitting the fixed feature data D1 and the dynamic feature data D2 to the training unit 41, the training unit 41 capturing the fixed feature data D1 and the dynamic feature data D2, generating the updated training model M1, and transmitting the updated training model M1 to the artificial intelligence model 35 for optimization, wherein the fixed feature data D1 and the dynamic feature data D2 generated by the information capture unit 37 are transmitted to the update information processing unit 411, or the fixed feature data D1 and the dynamic feature data D2 generated by the information capture unit 37 are directly transmitted to the training unit 41, in this embodiment, the fixed feature data D1 and the dynamic feature data D2 are firstly transmitted to the update information processing unit 411 as an implementation manner, wherein the update information processing unit 411 is mainly used to facilitate training of the training unit 41, but it is not limited thereto, wherein the update information processing unit 411 of the servo equipment 4 receives the fixed feature data D1 and the dynamic feature data D2 and generates the updated feature processing data D3, the update information processing unit 411 transmits the updated feature processing data D3 to the training unit 41, the training unit 41 captures the updated feature processing data D3 and generates the updated training model M1, the updated training model M1 is transmitted to the artificial intelligence model 35 to optimize the artificial intelligence model 35, wherein the updated training model M1 generated by the training unit 41 can be transmitted to the condition updating unit 42, and the condition updating unit 42 receives the updated training model M1 and transmits the updated training model M1 to the artificial intelligence model 35 for updating and optimization; and
step S53: the condition updating unit 42 receiving the at least one updated whitelist data D4, the at least one updated malicious behavior feature data D5 and the at least one updated blacklist data D6, and transmitting the at least one updated whitelist data D4, the at least one updated malicious behavior feature data D5 and the at least one updated blacklist data D6 to the whitelist database 32, the malicious behavior feature database 33 and the blacklist database 34, respectively, wherein after the condition updating unit 42 receives the updated whitelist data D4, the updated malicious behavior feature data D5 and the updated blacklist data D6, the condition updating unit 42 transmits the updated whitelist data D4, the updated malicious behavior feature data D5 and the updated blacklist data D6 to the whitelist database 32, the malicious behavior feature database 33 and the blacklist database 34, respectively, so that data in the whitelist database 32, the malicious behavior feature database 33 and the blacklist database 34 can be updated. When the central processing unit 31 judges the abnormal information I1, the central processing unit 31 compares and judges the whitelist database 32, the malicious behavior feature database 33 and the blacklist database 34 of updated data with the optimized artificial intelligence model 35. Thereby, the automatic dynamic secure connection system 1 is capable of achieving an efficacy of effectively updating a software execution status to correspond to updated malicious cyber attacks.

The condition updating unit 42 can be signally connected to the artificial intelligence model 35, the whitelist database 32, the malicious behavior feature database 33 and the blacklist database 34 through the control center 43, and the control center 43 performs secure connection and data control with the equipment information judging device 3 in the servo equipment 4, and data confirmation and updated data management with the user equipment 2. The control center 43 receives the updated training model M1, the updated whitelist data D4, the updated malicious behavior feature data D5 and the updated blacklist data D6 of the condition updating unit 42, and the control center 43 transmits the updated training model M1 to the artificial intelligence model 35 to optimize the artificial intelligence model 35, and transmits the updated whitelist data D4, the updated malicious behavior feature data D5 and the updated blacklist data D6 to the whitelist database 32, the malicious behavior feature database 33 and the blacklist database 34, respectively, so that data in the whitelist database 32, the malicious behavior feature database 33 and the blacklist database 34 can be updated. When the central processing unit 31 judges the abnormal information I1, the central processing unit 31 compares and judges the whitelist database 32, the malicious behavior feature database 33 and the blacklist database 34 of updated data with the optimized artificial intelligence model 35. Thereby, the automatic dynamic secure connection system 1 is capable of achieving an efficacy of effectively updating a software execution status to correspond to updated malicious cyber attacks.

It is to be understood that the above description is only preferred embodiments of the invention and is not used to limit the invention, and changes in accordance with the concepts of the invention may be made without departing from the spirit of the invention, for example, the equivalent effects produced by various transformations, variations, modifications and applications made to the configurations or arrangements shall still fall within the scope covered by the appended claims of the invention.

What is claimed is:

1. An automatic dynamic secure connection system comprising:
at least one user equipment; and
at least one equipment information judging device, the equipment information judging device having a central processing unit and being electrically connected to the user equipment, the user equipment executing a software program to generate at least one execution information, the central processing unit receiving the execution information and capturing an abnormal information in the execution information, the central processing unit comparing and judging the abnormal information with a whitelist database, a malicious behavior feature database and a blacklist database, and integrating with an artificial intelligence model analysis result, and then generating a judgment result according to a set condition, and the central processing unit determining whether to adjust a connection behavior according to the judgment result.

2. The automatic dynamic secure connection system as claimed in claim 1, wherein the equipment information judging device is provided with a connection unit, the connection unit is electrically connected to the central processing unit, and the central processing unit determines whether to adjust a connection behavior of the connection unit according to the judgment result.

3. The automatic dynamic secure connection system as claimed in claim 1, wherein the equipment information judging device further has an information capture unit, the information capture unit captures the abnormal information and generates at least one fixed feature data and at least one dynamic feature data from the abnormal information.

4. The automatic dynamic secure connection system as claimed in claim 3, further comprising a servo equipment, the servo equipment being signally connected to the user equipment, the servo equipment having a training unit and a condition updating unit, the servo equipment receiving the fixed feature data and the dynamic feature data and transmitting the fixed feature data and the dynamic feature data to the training unit, so that the training unit capturing the fixed feature data and the dynamic feature data, generating an updated training model, and transmitting the updated training model to the artificial intelligence model for optimization.

5. The automatic dynamic secure connection system as claimed in claim 1, wherein the equipment information judging device further comprises an original information processing unit, the original information processing unit is electrically connected to the central processing unit and the artificial intelligence model, the abnormal information captured by the central processing unit is transmitted to the original information processing unit and the original information processing unit filters noise.

6. The automatic dynamic secure connection system as claimed in claim 4, wherein the servo equipment further has an update information processing unit, the update information processing unit is signally connected to the information capture unit and the training unit, the update information processing unit receives the fixed feature data and the dynamic feature data and generates an updated malicious behavior feature data and transmits the updated malicious behavior feature data to the training unit, so that the training unit captures the updated malicious behavior feature data and generates the updated training model and transmits the updated training model to the artificial intelligence model for optimization.

7. The automatic dynamic secure connection system as claimed in claim 6, wherein the servo equipment further has a condition updating unit, the condition updating unit is signally connected to the training unit and the artificial intelligence model, and the condition updating unit receives the updated training model and transmits the updated training model to the artificial intelligence model for optimization.

8. The automatic dynamic secure connection system as claimed in claim 7, wherein the condition updating unit is signally connected to the whitelist database, the malicious behavior feature database and the blacklist database, the condition updating unit receives at least one updated whitelist data, at least one updated malicious behavior feature data and at least one updated blacklist data and transmits the at least one updated whitelist data, the at least one updated malicious behavior feature data and the at least one updated blacklist data to the whitelist database, the malicious behavior feature database and the blacklist database, respectively.

9. The automatic dynamic secure connection system as claimed in claim 8, wherein the servo equipment further comprises a control center, the control center is signally connected to the condition updating unit, the whitelist database, the malicious behavior feature database, the blacklist database and the artificial intelligence model, the control center receives the updated training model, the updated whitelist data, the updated malicious behavior feature data and the updated blacklist data of the condition updating unit, and transmits the updated training model, the updated whitelist data, the updated malicious behavior feature data and the updated blacklist data to the artificial intelligence model, the whitelist database, the malicious behavior feature database and the blacklist database, respectively.

10. An automatic dynamic secure connection method comprising:
at least one user equipment executing a software program to generate at least one execution information;
a central processing unit of an equipment information judging device receiving the execution information and capturing an abnormal information in the execution information;
the central processing unit comparing and judging the abnormal information with a whitelist database, a malicious behavior feature database and a blacklist database, and integrating with an artificial intelligence model analysis result, and then generating a judgment result according to a set condition; and
the central processing unit determining whether to adjust a connection behavior according to the judgment result.

11. The automatic dynamic secure connection method as claimed in claim 10, wherein the equipment information judging device is provided with a connection unit, the connection unit is electrically connected to the central processing unit, and the central processing unit determines whether to adjust a connection behavior of the connection unit according to the judgment result.

12. The automatic dynamic secure connection method as claimed in claim 10, an information capture unit of the equipment information judging device capturing the abnormal information and generating at least one fixed feature data and at least one dynamic feature data from the abnormal information.

13. The automatic dynamic secure connection method as claimed in claim 11, a servo equipment receiving the fixed feature data and the dynamic feature data and transmitting the fixed feature data and the dynamic feature data to a training unit, the training unit capturing the fixed feature data and the dynamic feature data, generating an updated training model, and transmitting the updated training model to the artificial intelligence model for optimization.

14. The automatic dynamic secure connection method as claimed in claim 11, wherein the abnormal information captured by the central processing unit is transmitted to an original information processing unit and the original information processing unit filters noise.

15. The automatic dynamic secure connection method as claimed in claim 12, wherein an update information processing unit of the servo equipment receives the fixed feature data and the dynamic feature data and generates an updated malicious behavior feature data and transmits the updated malicious behavior feature data to the training unit, the training unit captures the updated malicious behavior feature data and generates an updated training model and transmits the updated training model to the artificial intelligence model for optimization.

16. The automatic dynamic secure connection method as claimed in claim 14, wherein a condition updating unit of the servo equipment receives the updated training model and transmits the updated training model to the artificial intelligence model for optimization.

17. The automatic dynamic secure connection method as claimed in claim 15, wherein the condition updating unit receives at least one updated whitelist data, at least one updated malicious behavior feature data and at least one updated blacklist data and transmits the at least one updated whitelist data, the at least one updated malicious behavior feature data and the at least one updated blacklist data to the whitelist database, the malicious behavior feature database and the blacklist database, respectively.

18. The automatic dynamic secure connection method as claimed in claim 16, wherein a control center of the servo equipment receives the updated training model, the updated whitelist data, the updated malicious behavior feature data and the updated blacklist data of the condition updating unit, and transmits the updated training model, the updated whitelist data, the updated malicious behavior feature data and the updated blacklist data to the artificial intelligence model, the whitelist database, the malicious behavior feature database and the blacklist database, respectively.
